(19) United States
(12) Patent Application Publication
(10) Pub. No.: US 2026/0072172 A1
(43) Pub. Date: Mar. 12, 2026

(54) 3D CAMERA

(71) Applicant: Triple Win Technology (Shenzhen) Co., Ltd., Shenzhen (CN)

(72) Inventor: JUI-WEN CHANG, Shenzhen (CN)

(21) Appl. No.: 19/009,870

(22) Filed: Jan. 3, 2025

(30) Foreign Application Priority Data
Sep. 9, 2024 (CN) 202411259017.9

(51) Int. Cl. G01S 17/894; G01S 7/481; G01S 7/484; G01S 7/4863; G01S 7/4915; G02B 5/18; G02F 1/29

(52) U.S. Cl. CPC G01S 17/894; G01S 7/4813; G01S 7/4815; G01S 7/4863; G01S 7/4915; G02B 5/1828; G02F 1/292; G01S 7/484

(57) ABSTRACT

A 3D camera includes a light emission device for emitting a first light, a grating on an optical path of the first light, a time-of-flight sensor, a structured light sensor, and a controlling circuit. The grating is used to transmit the first light to generate a second transmitted light or diffract the first light to generate a third diffracted light. The time-of-flight sensor is used to receive and detect a fourth light reflected by an object illuminated by the second transmitted light. The structured light sensor is used to receive and detect a fifth light reflected by the object illuminated by the third diffracted light. The controlling circuit is used to control the grating to transmit or diffract the first light and generate a 3D image of the object by obtaining a travel time of the fourth light and/or a depth information of the fifth light.

### FIELD

The subject matter herein generally relates to stereoscopic imaging technology, in particular, relates to a 3D camera.

### BACKGROUND

With development and mature of three-dimensional (3D) vision technologies, 3D cameras have been widely used in field of automatic driving, high-end manufacturing, machine vision, etc. The 3D cameras determines position information and depth information of an object by directly or indirectly detecting a time of flight, or by calculating a displacement (relative to a light spot pattern on a flat object) of an encoded light spot pattern according to a specific algorithm. However, such methods for determining the position information and the depth information are difficult to balance a clarity of the image and a shooting distance limited by light attenuation.

### BRIEF DESCRIPTION OF THE DRAWINGS

Implementations of the present disclosure will now be described, by way of embodiment, with reference to the attached figures, wherein:

FIG. 1 shows a 3D camera according to an embodiment of the present disclosure, a grating of the 3D camera transmitting a first light to generate a second transmitted light.

FIG. 2 shows the grating of the 3D camera of FIG. 1 diffracting the first light to generate a third diffracted light.

FIG. 3 is a planar view of an embodiment of a substrate of the 3D camera in FIG. 1.

FIG. 4 is a planar view of another embodiment of a substrate of the 3D camera according to the present disclosure.

FIG. 5 shows the grating of the 3D camera in FIG. 1 when the grating is not receiving a first electrical signal.

FIG. 6 shows the grating of the 3D camera in FIG. 1 when the grating is receiving the first electrical signal.

FIG. 7 shows an arrangement of light spots of the second transmitted light in FIG. 1 projected in a plane.

FIG. 8 shows an arrangement of light spots of the third diffracted light in FIG. 2 projected in a plane.

FIG. 9 is a flow chart of a working process of the 3D camara according to an embodiment of the present disclosure.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts have been exaggerated to better illustrate details and features of the present disclosure.

Several definitions that apply throughout this disclosure will now be presented.

The term “comprising,” when utilized, means “including, but not necessarily limited to”; it specifically indicates open-ended inclusion or membership in the so-described combination, group, series, and the like.

“Above” means one layer is on top of another layer. In one example, it means one layer is situated directly on top of another layer. In another example, it means one layer is situated over the second layer directly or indirectly with more layers or spacers in between.

When a feature or element is herein referred to as being “on” another feature or element, it can be directly on the other feature or element or intervening features and/or elements may also be present. It will also be understood that, when a feature or element is referred to as being “connected”, to another feature or element, it can be directly connected, attached, or coupled to the other feature or element or an intervening features or elements may be present.

Stereoscopic imaging mainly includes time-of-flight technology and structured light technology. A 3D camera using the time-of-flight technology can determine position information and depth information of an object by directly or indirectly detecting a travel time of light, and a 3D camera using the structured light technology can determine the position information and the depth information of the object by calculating a displacement of an encoded light spot pattern according to a specific algorithm. A controlling circuit of the 3D camera is used to generate 3D images according to the position information and the depth information.

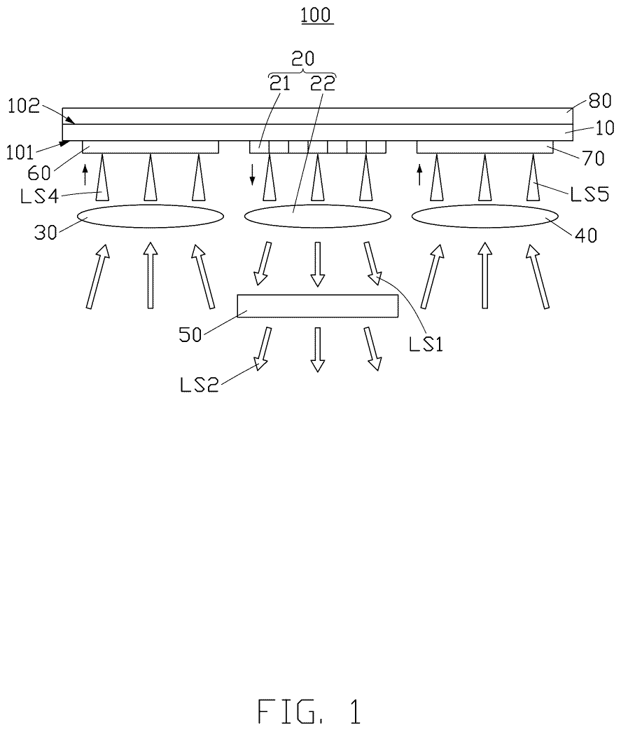

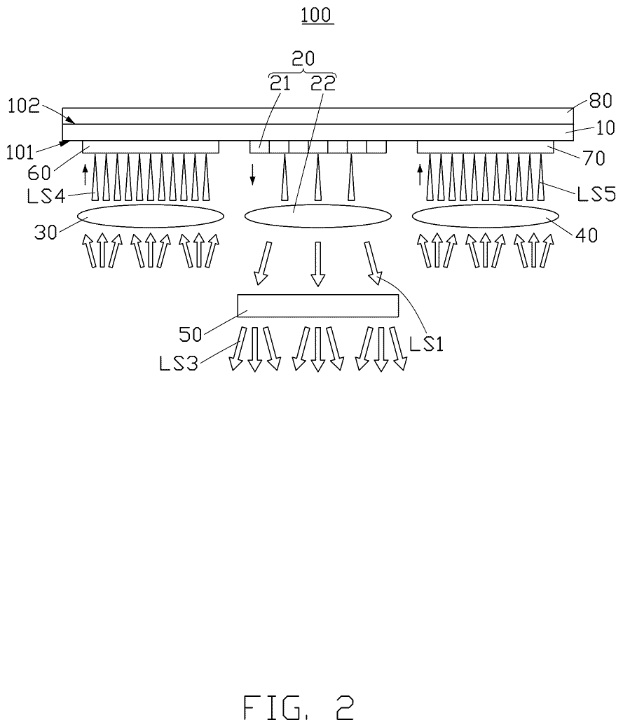

Referring to FIG. 1 and FIG. 2, a 3D camera 100 of this disclosure includes a substrate 10, a light emission device 20, a time-of-flight sensor 60, a structured light sensor 70, a grating 50 and a controlling circuit 80. The substrate 10 includes a first surface 101 and a second surface 102 parallel to each other, wherein the light emission device 20, the time-of-flight sensor 60 and the structured light sensor 70 are bonded on the first surface 101 of the substrate 10, and the controlling circuit 80 is on the second surface of the substrate 10. The grating 50 is on a light emitting side of the light emission device 20 and is spaced apart from the light emission device 20. The substrate 10 is formed with a plurality of conductive structures (not shown) extending from the first surface 101 to the second surface, and the conductive structures may include at least one of wires, metal pattern, metal pillar, solder pads and etc. The light emission device 20, the time-of-flight sensor 60 and the structured light sensor 70 are electrically connected to the controlling circuit 80 through the conductive structures.

The optical emission device 20 is used to emit a first light LS1, and the first light LS1 is laser light. The light emission device 20 includes a plurality of light sources 21 arranged in an array and an output collimating lens 22. Each light source 21 is used to emit laser light. Each Light source is 21 a vertical-cavity surface-emitting laser (VCSEL) or a light emitting diode (LED). The output collimation lens 22 is on a light emitting side of the light sources 21 emitting the laser light and is used to receive and collimate the laser light to generate the first light LS1. In this embodiment, the output collimating lens 22 may include at least one of a single lens, a combined lens, a microlens array, or a Fresnel lens. The output collimating lens 22 can balance reducing size and improving optical performance to improve a collimating effect. The laser light from the light sources 21 and is collimated by the output collimating lens 22 emits as the first light LS1.

The substrate 10 is formed by at least one of drilling, coating, and etching on a silicon substrate. The substrate 10 is formed with a circuit pattern (not shown) on the first surface 101 after at least one of the drilling, the coating, and the etching. The light sources 21, the time-of-flight sensor 60, and the structured light sensor 70 are arranged on the first surface 101 according to layout of the circuit pattern, and are electrically connected with the circuit pattern by corresponding conductive terminals of the circuit pattern.

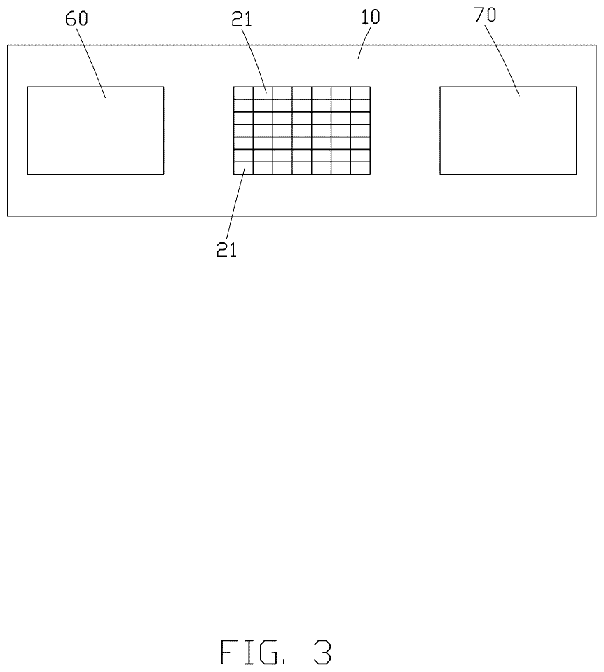

Referring to FIG. 3, in this embodiment, the substrate 10 is complete and continuous, and the light sources 21, the time-of-flight sensors 60, and the structured light sensors 70 are spaced apart on the first surface 101 of the substrate 10 and are electrically connected to the conductive terminals on the substrate 10.

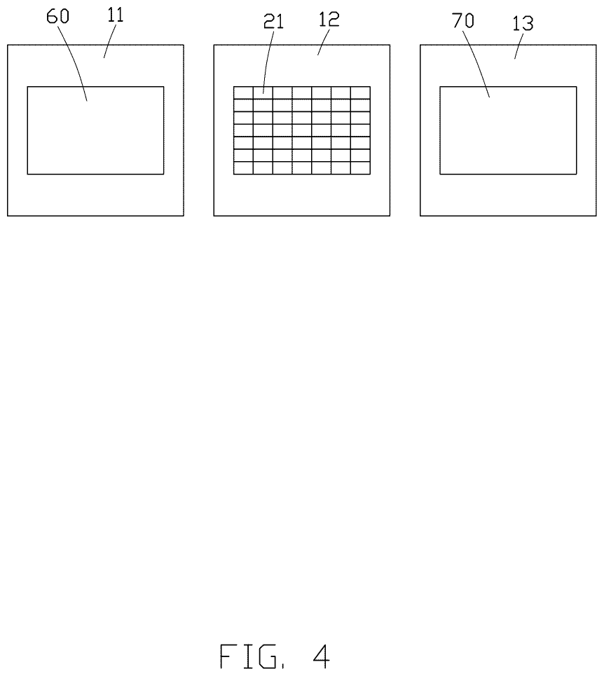

Referring to FIG. 4, in other embodiments of the disclosure, the 3D camera module 100 comprises three independent substrates, namely a substrate 11, a substrate 12 and a substrate 13. That is, the substrate 10 is divided into three parts spaced from each other. The circuit pattern is formed on the substrate 11, the substrate 12 and the substrate 13 respectively. The light sources 21 of the light emission device 20 are on a surface of the substrate 12 and are electrically connected to the circuit pattern on the substrate 12. The time-of-flight sensor 60 is on a surface of the substrate 11 and is electrically connected to the circuit pattern on the substrate 11. The structured light sensor 70 is on a surface of the substrate 13 and is electrically connected to the circuit pattern of the substrate 13.

A position relationship of the light sources 21 of the light emission device 20, the time-of-flight sensor 60 and the structured light sensor 70 are not limited in the present disclosure. The position relationship changes with usage scenarios of the 3D camera 100.

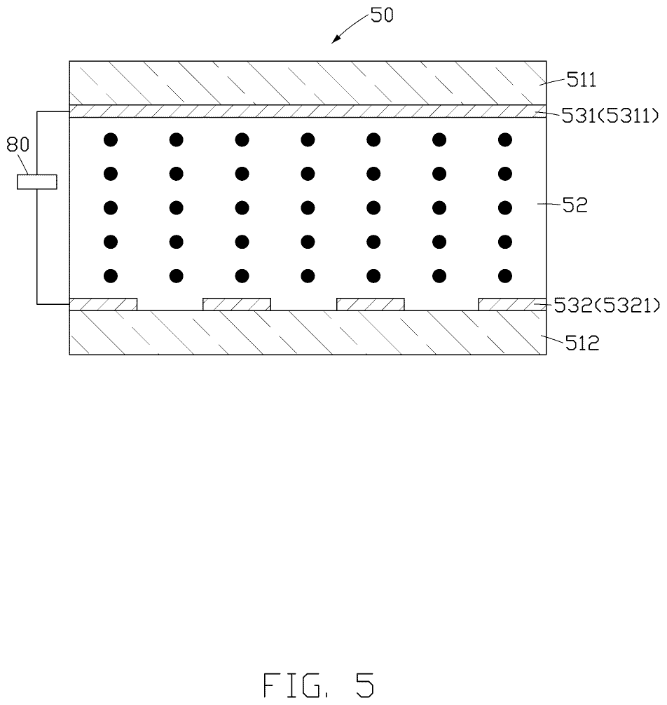

Referring to FIG. 1, the grating 50 is on an optical path of the first light LS1, and the grating 50 is an adjustable voltage liquid crystal grating. Referring to FIG. 5, the grating 50 includes a first glass substrate 511, a second glass substrate 512, and a liquid crystal layer 52 filled between the first glass substrate 511 and the second glass substrate 512. The first glass substrate 511 and the second glass substrate 512 are parallel and spaced apart, and the liquid crystal layer 52 has a molecular orientation that responds to a first electrical signal. The grating 50 further includes a first transparent conductive layer 531 which is transparent and electrically conductive and a second transparent conductive layer 532 which is transparent and electrically conductive. The first transparent conductive layer 531 is coated on a surface of the first glass substrate 511 near the liquid crystal layer 52. The first transparent conductive layer 531 includes a plurality of first electrodes 5311 spaced apart on the first glass substrate 511. The second transparent conductive layer 532 is coated on a surface of the second glass substrate 512 near the liquid crystal layer 52. The second transparent conductive layer 532 includes a plurality of second electrodes 5321 spaced apart on the second glass substrate 512. The first electrodes 5311 are periodically arranged on the first glass substrate 511, and the second electrodes 5321 are periodically arranged on the second glass substrate 512. That is, the grating 50 has a periodic electrode structure. The first transparent conductive layer 531 and the second transparent conductive layer 532 include transparent conductive materials such as tin doped indium oxide (ITO) or aluminum doped zinc oxide (Al doped ZnO, AZO).

The first transparent conductive layer 531 and the second transparent conductive layer 532 are respectively electrically connected to the controlling circuit 80. The controlling circuit 80 is used to apply a first electrical signal (voltage signal) to the first transparent conductive layer 531 and the second transparent conductive layer 532 respectively. When voltages applied to the first transparent conductive layer 531 and the second transparent conductive layer 532 are different, a voltage difference is generated between the first transparent conductive layer 531 and the second transparent conductive layer 532 to form a periodic electric field, causing the liquid crystal molecules in the liquid crystal layer 52 between the first transparent conductive layer 531 and the second transparent conductive layer 532 to undergo periodic changes in molecular orientation under an action of the periodic electric field.

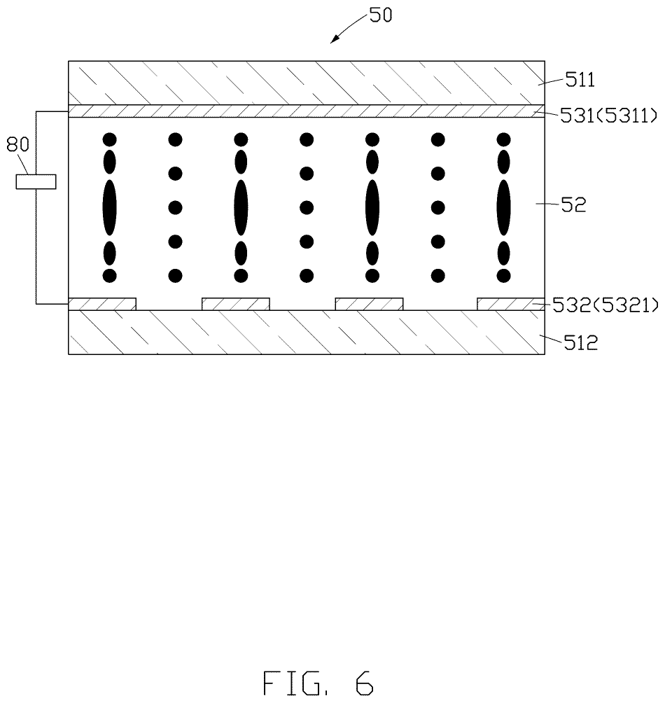

Referring to FIG. 5, when the controlling circuit 80 does not apply the first electrical signal to the first transparent conductive layer 531 and the second transparent conductive layer 532, or the controlling circuit 80 applies a same first electrical signal to the first transparent conductive layer 531 and the second transparent conductive layer 532, the first transparent conductive layer 531 and the second transparent conductive layer 532 have a same voltage, and the grating 50 transmits the first light LS1 and generates a second transmitted light LS2. Referring to FIG. 6, when the voltage difference formed between the first transparent conductive layer 531 and the second transparent conductive layer 532, the grating 50 diffracts the first light LS1 to generate a third diffracted light LS3.

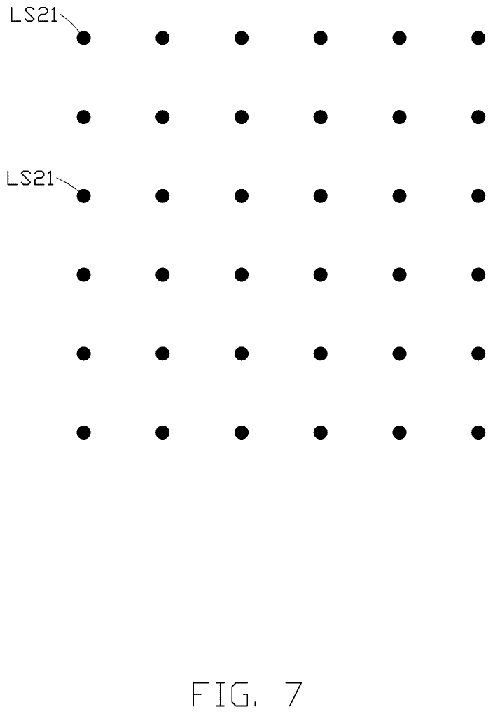

Referring to FIG. 1, the second transmitted light LS2 is generated after the grating 50 transmits the first light LS1. When the second transmitted light LS2 reaches on a surface of a plane object, an array including a plurality of first light spots LS21 shown in FIG. 7 are formed on the surface of the plane object. The second transmitted light LS2 includes a plurality of second transmitted light beams propagating in parallel, and each first light spot LS21 corresponds to one second transmitted light beam. A pattern of the first light spots LS21 on the surface of the plane object is the same as that of the first light LS1, and a beam density of the second transmitted light LS2 is the same as that of the first light LS1.

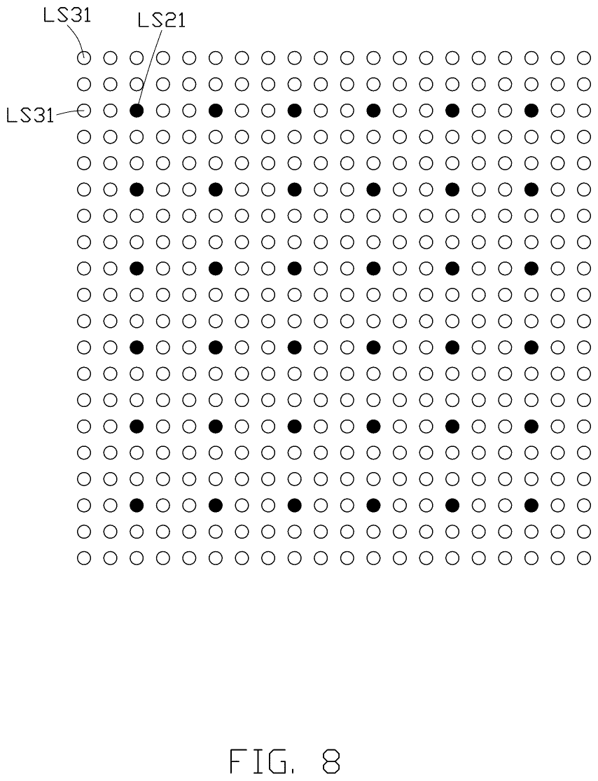

Referring to FIG. 2, the grating 50 diffracts the first light LS1 to generate the third diffract light LS3. The first light LS1 includes a plurality of first light beams. Due to diffraction effect, each first light beam of the first light LS1 can be diffracted into multiple third diffract light beams LS31 as shown in FIG. 8. That is, each first light beam corresponds to multiple third diffract light beams LS31. Thus, a light spot density of the third diffractive light LS3 is greater than that of the first light LS1, and a density of the third diffractive light beams is greater than those of the first light beams and the second transmitted light beams.

Referring to FIG. 1, the 3D camera 100 further includes a first receiving lens 30 and a second receiving lens 40. The first receiving lens 30 is used to converge the second transmitted light LS2 reflected by the object to generate a fourth light LS4, so that the fourth light LS4 forms a spot pattern corresponding to a surface structure of the object. The time-of-flight sensor 60 is used to receive the fourth light LS4 and generates the depth information of the surface of the object by calculation of the circuit. The second receiving lens 40 is used to converge the third diffractive light LS3 reflected by the object to generate a fifth light LS5, so that the fifth light LS5 forms a spot pattern corresponding to the surface of the object. The structured light sensor 70 is used to generate the depth information of the surface of the object according to triangulation.

The light emission device 20 is used to continuously send light pulses or modulated light (the first light LS1) to the object, and the time-of-flight sensor 60 is used to detect the light (the fourth light LS4) returned from the object and obtain the distance between the 3D camera 100 and the object by detecting a round-trip time of the light pulses or the modulated light. In at least one embodiment of the present disclosure, the Time-of-Flight sensor 60 can be a direct Time-of-Flight (dToF) sensor, which is used to directly detect a travel time of the fourth light LS4. In at least one embodiment of the present disclosure, the Time-of-Flight sensor 60 can be an indirect time-of-flight (iToF) sensor, which is used to detect a phase shift of the fourth light LS4 to indirectly obtain the travel time of the fourth light LS4.

The dToF sensor is used to calculate a time interval between sending the light pulses to the object and receiving the light reflected by the object to directly calculate the depth information of the object. The dToF sensor includes multiple single photon avalanche diodes (SPAD) and multiple time digital converters (TDC).

The iToF sensor is used to modulate light into a periodic signal of a certain frequency and measure a phase difference between the light sending to the object and the light reflected by the object to calculate the travel time of light indirectly. That is, the iToF sensor is used to generate the travel time by detecting the phase difference, rather than directly calculate the travel time.

The structured light sensor 70 works by calculating a displacement distance of a returned encoded light spot pattern through a specific algorithm to calculate the position and depth information of the object. The structured light sensor 70 calculates the distance between the object and the 3D camera 100 according to the displacement distance of the coded light spot pattern formed by the fifth light LS5.

The controlling circuit 80 includes a plurality of wires (not shown), each of which passes through the substrate 10 to electrically connect the optical emission devices 20, the grating 50, the time-of-flight sensor 60, and the structured light sensor 70 through the circuit pattern on the substrate 10. That is, the controlling circuit 80 is electrically connected to the optical emission device 20, the grating 50, the time-of-flight sensor 60 and the structured light sensor 70, respectively. The controlling circuit 80 is used to send a second electrical signal to control the optical emission device 20 emitting the first light LS1. The wires in the controlling circuit 80 is electrically connected with the first transparent conductive layer 531 and the second transparent conductive layer 532 of the grating 50, thus controlling the grating 50 to receive or not receive the first electrical signal, so that the grating 50 can transmit or diffract the first light LS1. When the grating 50 receives the first electrical signal, a voltage difference is generated between the first transparent conductive layer 531 and the second transparent conductive layer 532 to form a periodic electric field, so that the orientation of the molecules in the liquid crystal layer 52 changes with the electric field. When the grating 50 does not receive the first electrical signal, there is no electric field between the first transparent conductive layer 531 and the second transparent conductive layer 532, and the molecular orientation of the liquid crystal layer 52 remain unchanged. When the grating 50 transmits the first light LS1 to generate the second transmitted light LS2, the controlling circuit 80 controls the time-of-flight sensor 60 to receive and detect the fourth light LS4 reflected by the object according to the second transmitted light LS2, and obtain the three-dimensional image of the object according to the fourth light LS4. When the grating diffracted first light LS1 generates the third diffracted light LS3, the controlling circuit 80 controls the structured light sensor 70 or the time-of-flight sensor 60 to receive and detect the fifth light LS5 reflected by the third diffracted light LS3, and obtain depth information of the light spot on the object according to the fifth light LS5 to further generate a corresponding three-dimensional image.

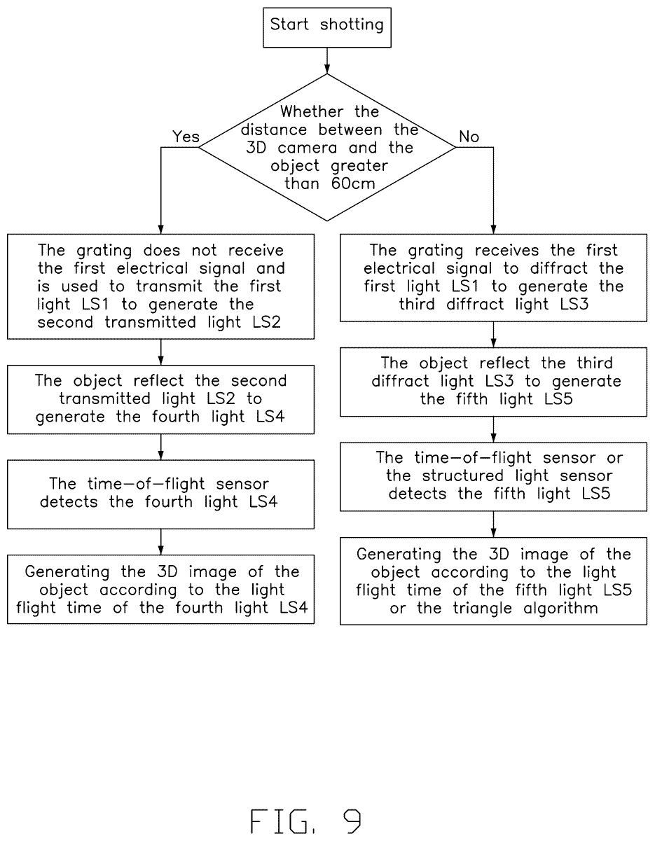

Referring to FIG. 9, a working process of the 3D camera 100 of this disclosure is as follows: when the 3D camera 100 takes pictures of the object, if the object is between 20 cm-60 cm away from the 3D camera 100, the controlling circuit 80 controls the grating 50 to receive the first electrical signal, so that the grating 50 diffracts the first light LS1 to generate the third diffract light LS3, and the object reflects the third diffract light LS3 to generate the fifth light LS5; the time-of-flight sensor 60 or the structured light sensor 70 generates a 3D image of the object based on the travel or the triangulation. When the 3D camera 100 takes pictures of the object, if the distance between the object and the 3D camera module 100 is 60 cm˜8 m, the controlling circuit 80 controls the grating 50 not to receive the first electrical signal, so that the grating 50 transmits the first light LS1 to generate the second transmitted light LS2, and the object reflects the second transmitted light LS2 to generate the fourth light LS4; the time-of-flight sensor 60 generates the 3D image of the object according to the travel time of the fourth light LS4.

The grating 50 of the 3D camera 100 transmits the first light LS1 to generate the second transmitted light LS2, or diffracts the first light LS1 to generate the third diffracted light LS3. The second transmitted light LS2 is used to generate the fourth light LS4 after being reflected by the object, and the third diffracted light LS3 is used to generate the fifth light LS5 after being reflected by the object. The beam density of the third diffracted light LS3 is greater than that of the second transmitted light LS2. Therefore, the number of the light spots formed when the third diffracted light LS3 reaches the surface of the object is greater than the number of the light spots formed when the second transmitted light LS2 reaches on the surface of the object, the beam density of the fifth light LS5 is greater than that of the fourth light LS4. The third diffractive light LS3 is conducive to obtaining higher resolution and clearer three-dimensional images. The beam intensity of the second transmitted light LS2 is greater than that of the third diffractive light LS3, so the second transmitted light LS2 with greater light intensity can propagate to a longer distance, and the second transmitted light LS2 is conducive to long-distance imaging.

When the distance between the object and the 3D camera 100 is a medium-short distance, the third diffracted light LS3 reaches the object has a low light intensity, so that the structured light sensor 70 is hard to detect the fifth light LS5 to generate the 3D images. On this occasion, the controlling circuit 80 controls the grating 50 to transmit the first light LS1 to generate the second transmitted light LS2, the time-of-flight sensor 60 receives and detects the fourth light LS4, thus obtaining the 3D images of the object according to the fourth light LS4. When the distance between the object and the 3D camera 100 is a long distance, the third diffracted light LS3 reaches the object has a high light intensity, so that the structured light sensor 70 can detect the fifth light LS5 to generate the 3D images. Since the beam density of the fifth light LS5 is greater than that of the fourth light LS4, a resolution of a 3D image of the object obtained by the controlling circuit 80 according to the fifth light LS5 is higher than that of a 3D image of the object obtained according to the fourth light LS4. Therefore, the controlling circuit 80 controls the grating 50 to diffract the first light LS1 to generate the third diffractive light LS3 when the object nears the 3D camera 100, so that the structured light sensor 70 receives and detects the fifth light LS5, thus obtaining the 3D image of the object according to the fifth light LS5. The 3D images of the object can both be obtained when the distance between the 3D camera 100 and the object is a medium-short distance or a long distance.

In this disclosure, the “medium-short distance” refers to the 3D camera 100 being between 20 cm-60 cm (20 cm and 60 cm are included) away from the object, and the “long distance” refers to the 3D camera 100 is between 60 cm-8 m (60 cm and 8 m are included) away from the object.

Finally, it should be noted that the above embodiments are only used to illustrate the technical solution of the present application and not to limit the present application. Although the present application has been described in detail with reference to preferred embodiments, one ordinary skill in the art should understand that the technical solution of the present application can be modified or equivalent replaced without departing from the spirit and scope of the technical solution of the present application.

What is claimed is:

1. A three dimensional (3D) camera comprising:
a light emission device configured for emitting a first light;
a grating on an optical path of the first light and configured to transmit the first light to generate a second transmitted light or configured to diffract the first light to generate a third diffracted light, wherein a beam density of the third diffracted light is greater than a beam density of the second transmitted light;
a time-of-flight sensor configured to receive and detect a fourth light reflected by an object illuminated by the second transmitted light;
a structured light sensor configured to receive and detect a fifth light reflected by the object illuminated by the third diffracted light; and
a controlling circuit electrically connected to the light emission device, the grating, the time-of-flight sensor, and the structured light sensor, and the controlling circuit configured to control the grating to transmit or diffract the first light and generate a 3D image of the object by obtaining a travel time of the fourth light detected by the time-of flight sensor and/or a depth information based on the fifth light detected by the structured light sensor.

2. The 3D camera according to claim 1, wherein the light emission device comprises a plurality of light sources arranged in an array, each of the plurality of light sources is configured to emit laser light to form the first light.

3. The 3D camera according to claim 2, wherein each of the plurality of light sources is a vertical-cavity surface-emitting laser or a light emitting diode.

4. The 3D camera according to claim 2, wherein the light emission device further comprises an output collimating lens between the plurality of light sources and the grating, the output collimating lens is configured to collimate the laser light emitted from each of the plurality of light sources to form the first light.

5. The 3D camera according to claim 1, further comprising a first receiving lens and a second receiving lens, wherein the first receiving lens is configured to converge the second transmitted light reflected by the object to generate the fourth light, and the second receiving lens is configured to converge the third diffracted light reflected by the object to generate the fifth light.

6. The 3D camera according to claim 1, wherein the time-of-flight sensor is a direct time-of-flight sensor configured to directly detect a travel time of the fourth light.

7. The 3D camera according to claim 6, wherein the time-of-flight sensor comprises a plurality of single photon avalanche diodes and a plurality of time to digital converters.

8. The 3D camera according to claim 1, wherein the time-of-flight sensor is an indirect time-of-flight sensor configured to detect a phase difference between the fourth light and the first light to indirectly obtain the travel time of the fourth light.

9. The 3D camera according to claim 8, wherein the time-of-flight sensor comprises an image sensor.

10. The 3D camera according to claim 1, wherein when the 3D camera is between 20 cm-60 cm away from the object, the controlling circuit further controls the structured light sensor or the time-of-flight sensor to generate the 3D image of the object.

11. The 3D camera according to claim 1, wherein when the 3D camera is 60 cm-8 m away from the object, the controlling circuit further controls the time-of-flight sensor is configured to generate the 3D image of the object.

12. The 3D camera according to claim 1, further comprising at least one substrate; and
the light emission device, the time-of-flight sensor, the structured light sensor, and the controlling circuit are on the substrate, and the grating is on a light emitting side of the light emission device and is spaced apart from the light emission device.

13. The 3D camera according to claim 12, wherein the substrate has a first surface and a second surface parallel to each other, the light emission device, the time-of-flight sensor, and the structured light sensor are on the first surface, and the controlling circuit is on the second surface.

14. The 3D camera according to claim 13, wherein the light emission device is between the time-of-flight sensor and the structured light sensor and is spaced apart from the time-of-flight sensor and the structured light sensor.

15. The 3D camera according to claim 12, wherein the 3D camera comprises three independent substrates, and the light emission device, the time-of-flight sensor, and the structured light sensor are respectively on one of the three independent substrates.

16. The 3D camera according to claim 1, wherein the grating comprises a first transparent conductive layer which is transparent and electrically conductive, a second transparent conductive layer which is transparent and electrically conductive, and a liquid crystal layer between the first transparent conductive layer and the second transparent conductive layer, and the first transparent conductive layer and the second transparent conductive layer are electrically connected to the controlling circuit; and
the controlling circuit is further configured to apply voltage signals to the first transparent conductive layer and the second transparent conductive layer to control a molecular orientation of liquid crystal molecules in the liquid crystal layer.

17. The 3D camera according to claim 16, wherein when the controlling circuit applies a same voltage on the first transparent conductive layer and the second transparent conductive layer, the grating transmits the first light to generate the second transmitted light.

18. The 3D camera according to claim 16, wherein when the controlling circuit applies different voltages on the first transparent conductive layer and the second transparent conductive layer, the grating diffracts the first light to generate the third diffracted light.
